(19) United States
(12) Patent Application Publication
(10) Pub. No.: US 2002/0085651 A1
(43) Pub. Date: Jul. 4, 2002

(54) Removing frequency and timing offsets in digital transmitters and receivers

(76) Inventor: Jian Gu, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/949,069

(22) Filed: Sep. 7, 2001

Related U.S. Application Data
(60) Provisional application No. 60/240,621, filed on Oct. 16, 2000.
(60) Provisional application No. 60/242,474, filed on Oct. 23, 2000.
(60) Provisional application No. 60/243,540, filed on Oct. 26, 2000.

(51) Int. Cl. H04L 27/06

(52) U.S. Cl. 375/344

(57) ABSTRACT

A frequency and timing offset adjustment system for a digital signal without changing the local oscillator frequency and the local sampling clock frequency. The frequency offset adjustment system includes a sine function look-up table, an interpolator, and an adjusting element. The look-up table provides sine sample values at an interval close enough to produce said sine sample values with sufficient accuracy, but far enough to enable reduction in size of the look-up table. For timing adjustment, a mechanism enables selection of an appropriate set of samples for a current symbol based on observation of accumulated timing error.

### BACKGROUND

1. Field of the Invention

The present invention relates to transmitters and receivers. More particularly, the invention relates to improved frequency and time synchronization of the digital transmitters and receivers.

2. Prior Art

In digital communication systems, it is desirable to remove frequency offsets between a transmitter and a receiver. A commonly used approach may be to measure the offset after demodulation of the input signal, and to convert the digitized offset signal to analog signal. This analog signal may then be used to control the Voltage Controlled Oscillator (VCO). However, this approach requires carefully configuring components such as analog loop filter and VCO.

Another approach may be to accomplish this offset removal digitally by using a digital mixer/tuner to remove the offset and tune to the desired frequency. The digital approach may utilize a stable fixed source frequency to define sampling times at which digital sinusoidal sample values are produced. The primary building block for this approach is the direct digital synthesizer (DDS).

A DDS typically includes a phase accumulator and a sine function lookup table. The input to the phase accumulator is a frequency control word that determines the periodicity of the phase accumulator. The phase accumulator is updated to a digital sine or cosine sample using the sine or cosine function lookup table. However, the prior art configuration uses as many bits in the look-up table as can be accommodated by the DAC. Accordingly, the table may become too large and complex.

Further, the synchronized frequency samples may be processed using Orthogonal Frequency Division Multiplexing (OFDM), which works by sending many frequency-multiplexed, narrow band signals (subcarriers) together to form a wide band, high-speed radio link. Frequency synchronization may be required so that the closely spaced narrowband signals are not frequency shifted into a position where they interfere with each other. Timing recovery may also be needed to position the signal in the optimum sampling window and to make sure the phases of the subcarriers are properly aligned. Before a received OFDM symbol can be decoded, frequency and time synchronization of the signal have to be determined.

An OFDM transmitter and a corresponding OFDM receiver typically operate at identical and stable subcarrier frequencies, but the clock cycle defining the symbol times in the transmitter and receiver may be offset with respect to each other by a certain symbol time offset. Time synchronization between the transmitter and receiver clock cycles may be accomplished by determining this offset. However, the traditional method of performing time synchronization involves adjusting sampling clock, which requires a phase-locked loop with many analog components. Accordingly, the required correction time may be too long for the analog loop to respond to the adjustment.

### SUMMARY

The present invention, in one aspect, describes a frequency offset adjustment system for a digital signal where the frequency of the local oscillator is fixed. The system includes a sine function look-up table, an interpolator, and an adjusting element. The look-up table provides sine sample values at an interval close enough to produce said sine sample values with sufficient accuracy, but far enough to enable reduction in size of the look-up table. The interpolator receives the sine sample values, and produces sine and cosine sample values at a particular input phase value between the sine sample values by using numerical interpolation. The adjusting element is configured to receive the digital signal, and to adjust frequency offset on the signal by mixing samples of the digital signal with the sine and cosine sample values calculated based on sample index of the digital signal and the frequency offset.

In another aspect, the present invention describes a method for adjusting an accumulated timing offset of a digital signal by selecting appropriate samples of the signal without adjusting the local sampling clock frequency. The method includes taking M samples of sample indices from a sample buffer, taking N samples among M samples, and performing N-point fast Fourier transform (FFT) to determine an estimated modulating symbol for k-th sub-carrier. The method further includes determining a modulating symbol for the k-th sub-carrier by multiplying the estimated symbol by exp (−j2πkΔ_{F}τ), where k=0, 1, . . . , N−1 and τ is the accumulating timing offset.

### BRIEF DESCRIPTION OF THE DRAWINGS

FIG. 1 illustrates a frequency offset adjustment system according to an embodiment of the present invention.

FIG. 2 illustrates the process of providing interpolated values of sine and cosine function samples in a look-up table interpolator according to an embodiment of the present invention.

FIGS. 3A and 3B are flowcharts describing a timing offset adjustment process according to an embodiment of the present invention.

### DETAILED DESCRIPTION

In recognition of the above-stated difficulties associated with conventional designs of synchronization process, the present invention describes embodiments for improved frequency and time synchronization of the digital transmitters and receivers. Frequencies of the local oscillator and the local sampling clock are derived from the same frequency source, such as a crystal oscillator. The local oscillator generates reference signal to mixers for down-conversion, while the local sampling clock controls the process to generate digital samples. In the present embodiments, an assumption is made that the frequency of the reference (e.g. the crystal oscillator) is fixed. Hence, fixed offset may exist between the remote transmitter and the local receiver.

Frequency synchronization is performed by a frequency offset adjustment system that includes a sine function look-up table interpolator that provides interpolated values of sine and cosine function samples. This enables the look-up table to be configured as small as possible. Timing synchronization is provided by a technique that enables selection of appropriate sets of samples based on observation of accumulated timing error for OFDM receivers/transmitters without adjusting the local sampling clock. Consequently, for purposes of illustration and not for purposes of limitation, the exemplary embodiments of the invention are described in a manner consistent with such use, though clearly the invention is not so limited.

A frequency offset adjustment system, such as a digital tuner, for adjusting frequency offset of an input digital signal is described below. The digital tuner of the present embodiments uses a sine function look-up table that is significantly smaller than that of the conventional digital tuner. Particularly, the sine function look-up table should provide sine sample values at an interval close enough to provide the sample values with sufficient accuracy, but far enough to enable reduction in the size of the look-up table. A numerical interpolation technique, along with other simplification techniques, enables the reduction in size of the sine look-up table. This keeps the resolution of the digital tuner high while keeping the complexity of the implementation low.

For a complex digital signal including in-phase (I) and quadrature (Q) components, adjusting frequency offset is equivalent to multiplying the input I-Q complex signal by e^{-j2πΔft} or cos(2πΔft)−j sin(2πΔft), where Δf is the frequency offset.

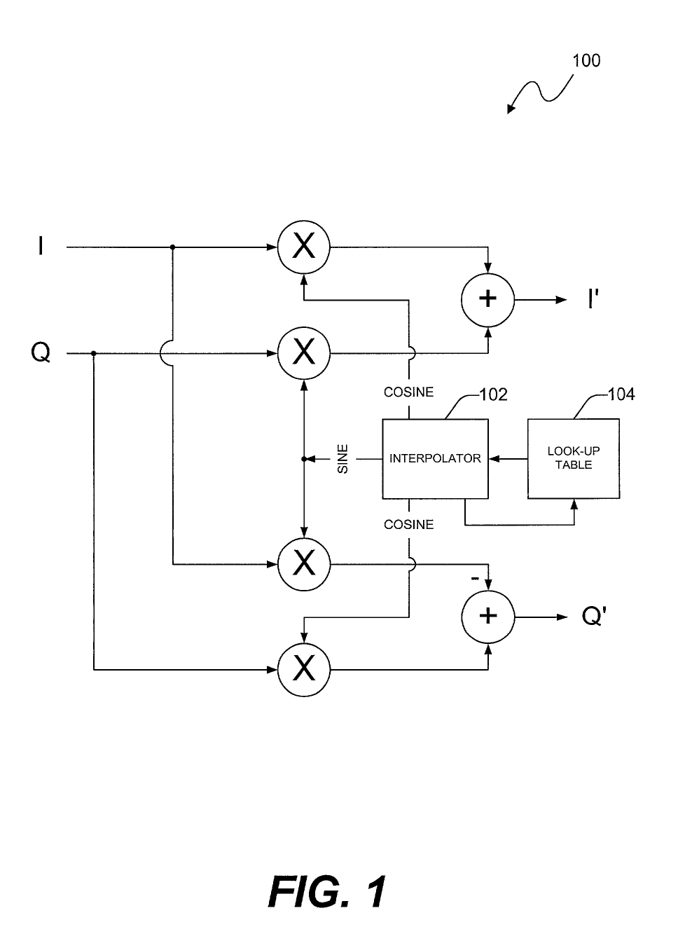

FIG. 1 illustrates a frequency offset adjustment system 100 according to an embodiment of the present invention. In the illustrated embodiment, sine and cosine function samples are derived from a sine function lookup table interpolator 102. The interpolator 102 is configured to receive values from a look-up table 104 and to provide sine and cosine samples at any particular phase value. The sine and cosine samples are derived by numerical interpolation as described below. The look-up table 104 is configured to provide a minimum number of sine function entries so that the table 102 may be implemented as small as possible.

Let

$${f}_{s} = \frac{1}{{T}_{s}}$$

be the sampling frequency and i be the sampling index. Then the sampled sin (27πΔft) is sin (2πΔfiT_{S}). Moreover, let S be the size of the sine table, which is defined as f_{ref}

$${f}_{ref} = \frac{{f}_{s}}{S} .$$

.Thus,

$$S = \frac{{f}_{s}}{{f}_{ref}} , \qquad ( 1 )$$

where f_{ref}=reference frequency, and

f_{S}=sampling frequency.

Further, let

$${f}_{min} = \frac{{f}_{ref}}{R} ,$$

where fₘᵢₙ is the minimum adjustable frequency step. Then, the frequency offset, Δf, may be defined as

$$Δ f = {Kf}_{min} = ( \frac{K}{R} ) {f}_{ref} , \qquad ( 2 )$$

where Δf=frequency offset,

K=scaling Factor, and

R=Resolution Factor.

The scaling factor (K) is a variable depending on the received signal's frequency error provided by the frequency error estimator of the receiver. The resolution factor (R) is a pre-determined constant before signal reception.

Numerical interpolation may be implemented as follow. Define

$$sin\_table [ n ] = sin ( 2 π {f}_{ref} {T}_{s} n ) = sin ( 2 π \frac{{f}_{s}}{S} {T}_{s} n ) = sin ( \frac{2 π n}{S} ) \qquad ( 3 )$$

for 0≦n<S. Note that

$$\vert {Kf}_{min} \vert < \frac{{f}_{s}}{2} .$$

For any K>0 and sample index i, determine n and m such that

$$n \leq \frac{iK}{R} < n + 1$$

and m=iK(modR).

Using equation (2) above,

sin(2πΔfiT_{S})=sin(2πKfₘᵢₙiT_{S})=

$$sin ( 2 π Δ {fiT}_{s} ) = sin ( 2 π {Kf}_{min} {iT}_{s} ) == sin ( 2 π \frac{iK}{R} {f}_{ref} {T}_{s} ) .$$

Accordingly, by interpolating and using equation (3) above,

$$\begin{matrix}sin ( 2 π Δ {fiT}_{s} ) = \frac{R - m}{R} sin ( 2 π n / S ) + \frac{m}{R} sin ( 2 π ( n + 1 ) / S ) \\ = \frac{R - m}{R} sin\_table [ n \% S ] + \\ \frac{m}{R} sin\_table [ ( n + 1 ) \% S ] ,\end{matrix} \qquad ( 4 )$$

where e is the modulus division operator (i.e. ‘mod’).

The size of the sine table (i.e. sin_table in above equations) may be further reduced by a factor of four by taking advantage of the quadrature symmetry of the sine and cosine functions. A two-bit control word may be used to select appropriate sign of the value. In particular, it is noted that in the range of [0,π] or [π, 2π], the sine function is symmetrical about

$$\frac{π}{2} or \frac{3 π}{2} ,$$

respectively. In addition, the sine value is complemented when the phase is increased or decreased by π. Hence, the complement of the sine value may be obtained by simply using the control bits to control the polarity of the output value.

Further, for cosine function, cos(2πΔfiT_{S})=

$$cos ( 2 π K {f}_{min} i {T}_{s} ) = cos ( 2 π \frac{K}{R} {f}_{ref} i {T}_{s} ) .$$

Accordingly,

$$cos ( 2 πΔ f i {T}_{s} ) = \frac{R - m}{R} sin\_table [ ( n + \frac{S}{4} ) \% S ] + \frac{m}{R} sin\_table [ ( n + 1 + \frac{S}{4} ) \% S ] . \qquad ( 5 )$$

For K<0, let K′=−K, repeat the above for K′ and then change sign of the resulting value for sine function and use the same resulting value for cosine function. The effective frequency adjustable range is

$$\pm \frac{{f}_{s}}{2} .$$

The minimum step

$${f}_{min} = \frac{{f}_{s}}{R S} .$$

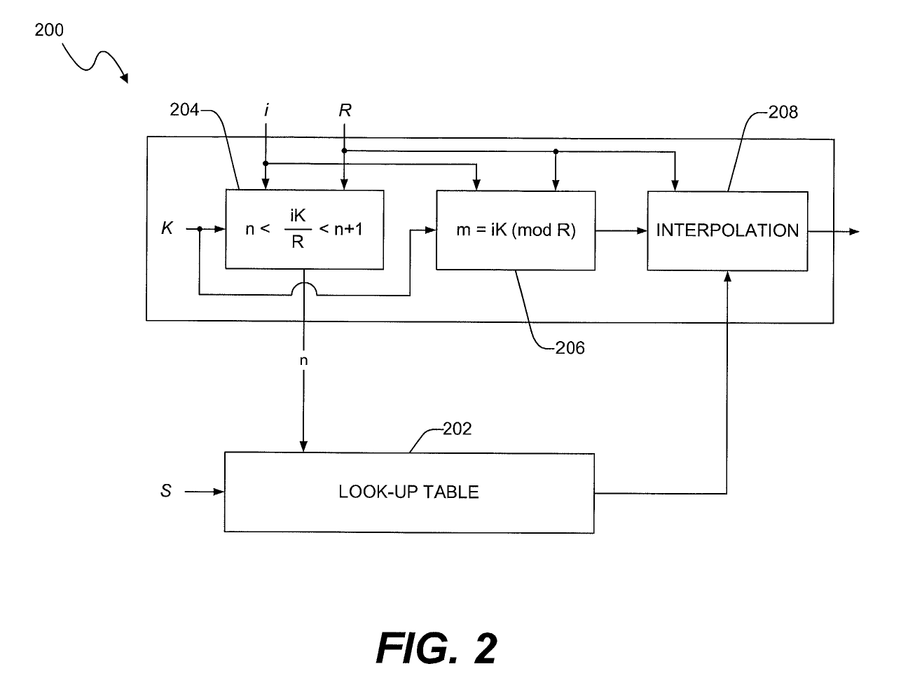

FIG. 2 illustrates the above-described process of providing interpolated values of sine and cosine function samples in a look-up table interpolator 200 according to an embodiment of the present invention. In the illustrated embodiment, the parameters n and m are computed in modules 204 and 206, respectively. The value of n is sent to a look-up table 202. For sine calculation, the look-up table 202 returns sine values at n%S and (n+1)%S, where % is a modulus operator. The interpolation module 208 receives the parameters m and R, as well as sine values from the look-up table 202, to interpolate between two sine values. The interpolation equation is provided in equation (4) above. Similar calculation may be performed for cosine function according to equation (5) above.

The illustrated embodiment of FIG. 2 is applicable for a case where K>0. As stated above, for K<0, let K′=−K, repeat the above process for K′ and then change the sign of the resulting value for sine function and use the same resulting value for cosine function.

An example implementation of the above-described system 100 is evaluated as follows. Let S=1024 and R=512. For f_{S}=20 MHz, adjustable frequency range is ±10 MHz. Moreover, minimum adjustable frequency step fₘᵢₙ=20 MHz/(1024*512)≈40 Hz. Considering Taylor series expansion of the sine function,

$$sin ( x ) = sin ( {x}_{0} ) + cos ( {x}_{0} ) ( x - {x}_{0} ) - \frac{sin ( {x}_{0} )}{2} {( x - {x}_{0} )}^{2} .$$

Further,

$$\vert x - {x}_{0} \vert \leq \frac{2 π}{1024} = 6.1359 * {10}^{- 3}$$

=6.1359*10⁻³ for S=1024. Therefore, the numerical error due to interpolation is less than 1.8825*10⁻⁵, which is better than 16-bit quantization error (i.e. 3.0518*10⁻⁵) over (−1, +1) for the sine function.

Accordingly, once the frequency samples have been synchronized using the above-described frequency offset adjustment system 100, the samples may be processed by baseband processors such as a below-described technique using enhanced OFDM according to an embodiment of the present invention.

In OFDM, serially input symbol streams are divided into a predetermined unit block. The divided symbol streams of each unit block are converted into N number of parallel symbols. The N number of parallel symbols are multiplexed and added by using a plurality of subcarriers having different frequencies, respectively, according to Inverse Fast Fourier Transform (IFFT) technique. The added data are transmitted via the channel. Thus, the N number of parallel symbols is defined as one unit block, and each subcarrier of the unit block has an orthogonal characteristic, which does not have any influence on sub-channels. Compared to a conventional single carrier transmission method, OFDM may reduce the inter-symbol interference (ISI) caused by the multi-path fading by maintaining the same symbol transmission rate and increasing symbol period as much as by the number of sub-channels (N). Especially, in OFDM, a guard interval (GI) is inserted between the transmitted symbols to enhance the capability of the ISI reduction, making it possible to realize a simplified structure of channel equalizer. In contrast to a conventional Frequency Division Multiplexing (FDM) type, OFDM has a characteristic that spectrums of each sub-channel are superimposed causing it to have higher bandwidth efficiency.

Accordingly, present embodiments enable correction of accumulated timing error for OFDM receivers/transmitters without adjusting the local sampling clock. Therefore, the effect of the accumulated timing error due to the fixed clock frequency offset between the source and the destination may be removed without adjusting the local clock frequency. The technique is described below.

Let

$${f}_{s} = \frac{1}{{T}_{s}}$$

be the sampling frequency at the source and x(nT_{S}) be samples of a modulated OFDM symbol, x(t). Then, N samples within an OFDM symbol may be equivalently expressed as

$$x ( {nT}_{s} ) = {\sum }_{k = 0}^{N - 1} X ( k {Δ}_{F} ) \cdot exp ( j2π k {Δ}_{F} {nT}_{s} ) , \qquad ( 6 )$$

where n=0, . . . , N−1,

Δ_{F}=frequency spacing between sub-carriers,

X(kΔ_{F})=modulating symbol of k-th sub-carrier.

An OFDM symbol of M samples is generated by repeating the last M-N samples of the N IFFT samples of equation (6) before the N IFFT samples. The M-N samples are referred to as Cyclic Prefix (CP). At the receiver, the middle N samples are used for demodulation (i.e., sample numbers

$$\frac{N - M}{2} to ( N - 1 ) + \frac{N - M}{2} .$$

Therefore, when there is no clock frequency offset between the source and the destination, the modulating symbols for substantially all sub-carriers may be recovered from the N time-domain samples by

$$X ( {kΔ}_{F} ) = \frac{1}{N} {\sum }_{n = 0}^{N - 1} x ( {nT}_{s} ) \cdot exp ( - {j2πkΔ}_{F} {nT}_{s} ) , \qquad ( 7 )$$

where k=0, . . . , N−1.

Defining

$${Δ}_{F} {T}_{s} = \frac{{Δ}_{F}}{{f}_{s}} = \frac{1}{N} ,$$

the above expressions form an IFFT/FFT pair as

$$\begin{matrix}x ( {nT}_{s} ) = {\sum }_{k = 0}^{N - 1} X ( {kΔ}_{F} ) \cdot exp ( j2πkn / N ) , IFFT \\ where n = 0 , … , N - 1. And , & ( 8 ) \\ X ( {kΔ}_{F} ) = \frac{1}{N} {\sum }_{n = 0}^{N - 1} x ( {nT}_{s} ) \cdot exp ( - j2πkn / N ) , FFT \\ where k = 0 , … , N - 1. & ( 9 )\end{matrix}$$

However, when there is a fixed clock frequency offset (or equivalently fixed sampling duration offset) between the source and the destination, these equations need to be modified.

Let T_{S} and T_{sd}=T_{S}+δ (be the sampling durations of the source and the destination, respectively. δ is the timing error over one sampling duration (assume δ>0). Using the same FFT technique to demodulate the modulating symbol of each sub-carrier at the destination,

$$\hat{X} ( {kΔ}_{F} ) = \frac{1}{N} {\sum }_{n = 0}^{N - 1} x [ n ( {T}_{s} + δ ) + LMδ ] \cdot exp ( - j2πkn / N ) . \qquad ( 10 )$$

\hat{X}(kΔ_{F}) for k=0, . . . , N−1 is derived for the k-th modulating symbol on the k-th sub-carrier. L is the number of OFDM symbols received from the beginning to the current symbol. Mδ (M>N) is the accumulated timing error after one OFDM symbol, which includes M samples.

Magnitude of δ, |δ|, is usually very small relative to the sampling duration of the source, T_{S} (e.g., |δ|/T_{S}<20·10⁻⁶ or 20 PPM). Moreover, accumulated timing error |Nδ| over N samples within one OFDM symbol (e.g., N=64) is also small relative to T_{S}. Assuming τ=LMδ, where |τ| is very small relative to T_{S},

$$\begin{matrix}\hat{X} ( {kΔ}_{F} ) = \frac{1}{N} {\sum }_{n = 0}^{N - 1} x ( n ( {T}_{s} + δ ) + τ ) \cdot exp ( - j2πkn / N ) \\ \approx \frac{1}{N} {\sum }_{n = 0}^{N - 1} x ( {nT}_{s} ) \cdot exp ( - j2πkn / N ) = X ( {kΔ}_{F} ) .\end{matrix} \qquad ( 11 )$$

However, after several OFDM symbols (e.g., several hundred symbols) the accumulated timing error may be large enough to make the above approximation incorrect.

To correct this accumulated timing error, the present embodiments derive the values of X(kΔ_{F}) for k=0, . . . , N−1 from the samples x[n(T_{S}+δ)+τ]=x(nT_{S}+nδ+τ), where n=0, . . . , N−1 at the destination. However, the clock at the destination is fixed. Thus, this timing offset may be removed by including (or excluding) one prior sample and excluding (or including) one subsequent sample to accommodate the accumulated timing error. This ensures that the set of samples is taken from the middle of the samples (M samples and M>N) of the OFDM symbol at any particular time.

The actual calculations needed to recover X(kΔ_{F}) are

$$\begin{matrix}X ( {kΔ}_{F} ) = \frac{1}{N} {\sum }_{n = 0}^{N - 1} x ( n ( {T}_{s} + δ ) + τ ) \cdot exp ( - {j2πkΔ}_{F} ( n ( {T}_{s} + δ ) + τ ) ) \\ = \frac{1}{N} {\sum }_{n = 0}^{N - 1} x ( n ( {T}_{s} + δ ) + τ ) \cdot exp ( - j2πkn / N ) \cdot exp ( - {j2πkΔ}_{F} ( nδ + τ ) ) \\ \approx \frac{1}{N} {\sum }_{n = 0}^{N - 1} x ( n ( {T}_{s} + δ ) + τ ) \cdot exp ( - j2πkn / N ) \cdot exp ( - {j2πkΔ}_{F} τ ) .\end{matrix} \qquad ( 12 )$$

However, with a fixed local oscillator at the destination having timing offset that is drifting, the following FFT operation based on equation (11) may be performed with the samples of offset sampling instances,

$$\hat{X} ( {kΔ}_{F} ) = \frac{1}{N} {\sum }_{n = 0}^{N - 1} x ( n ( {T}_{s} + δ ) + τ ) \cdot exp ( - j2πkn / N ) . \qquad ( 13 )$$

Therefore, for small δ or large τ, combining equations (12) and (13) produces

\hat{X}(kΔ_{F})·exp(−j2kΔ_{F}τ)≈X(kΔ_{F}). (14)

This is a good approximation when nδ<Nδ<<T_{S} or nδ<<τ.

If τ=LMδ for the current OFDM symbol (assuming τ>0) is so large that T_{S}+δ<τ<2(T_{S}+δ), then equation (12) may use a set of samples {x(n(T_{S}+δ)+τ):n=−1, . . . N−2} (one prior sample). Then,

$$\begin{matrix}X ( {kΔ}_{F} ) = \frac{1}{N} {\sum }_{n = 0}^{N - 1} x ( n ( {T}_{s} + δ ) + τ - {T}_{s} - δ ) \cdot exp ( - {j2πkΔ}_{F} ( n ( {T}_{s} + δ ) + τ - {T}_{s} - δ ) ) \\ = \frac{1}{N} {\sum }_{n = 0}^{N - 1} x ( n ( {T}_{s} + δ ) + τ - {T}_{s} - δ ) \cdot exp ( - j2πkn / N ) \cdot exp ( - {j2πkΔ}_{F} ( nδ + τ - {T}_{s} - δ ) ) \\ \approx \frac{1}{N} {\sum }_{n = 0}^{N - 1} x ( n ( {T}_{s} + δ ) + τ - {T}_{s} - δ ) \cdot exp ( - j2πkn / N ) \cdot exp ( - {j2πkΔ}_{F} ( τ - {T}_{s} - δ ) )\end{matrix} \qquad ( 15 )$$

However, if y(n)=x(n(T_{S}+δ)+τ−T_{S}−δ), for n=0, . . . ,N−1, then

$$\begin{matrix}\hat{X} ( {kΔ}_{F} ) = \frac{1}{N} {\sum }_{n = 0}^{N - 1} y ( n ) \cdot exp ( - j2πkn / N ) \approx X ( {kΔ}_{F} ) \cdot exp ( {j2πkΔ}_{F} ( τ - {T}_{s} - δ ) ) \\ = X ( {kΔ}_{F} ) \cdot exp ( {j2πkΔ}_{F} ( {τ}^{′} ) )\end{matrix} \qquad ( 16 )$$

where τ′=τ−T_{S}−δ.

In summary, if, at the beginning of any OFDM symbol, T_{S}+δ<τ<2(T_{S}+δ), then the new delay (or a total timing drift) reference τ′=τ−(T_{S}+δ) should be set. Furthermore, a new set of samples (one prior sample) should be used for FFT. This avoids drifting of samples out of the M-sample window from the point of view of the source. After a number of symbols have been received, the above procedure may be repeated.

Similarly, for δ<0, a set of samples used in the FFT operation for each OFDM symbol may be moved to one subsequent sample. The delay reference may be set to τ′=τ+T_{S}+δ whenever −(T_{S}+δ)>τ>−2(T_{S}+δ).

Accordingly, the result of the timing offset adjustment process is (T_{S}+δ)≧τ≧−(T_{S}δ) and X(kΔ_{F})≈\hat{X}(kΔ_{F})·exp(−j2πkΔ_{F}τ), where {\hat{X}(kΔ_{F}):k=0, . . . ,N−1} is a set of frequency domain samples resulting from FFT operation on an appropriate set of time domain samples.

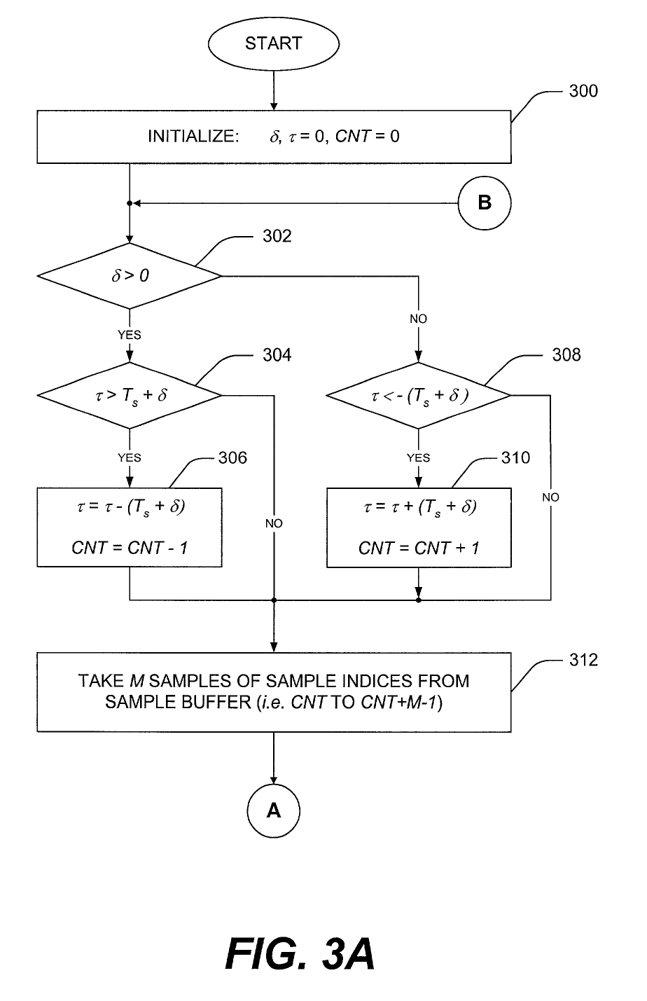

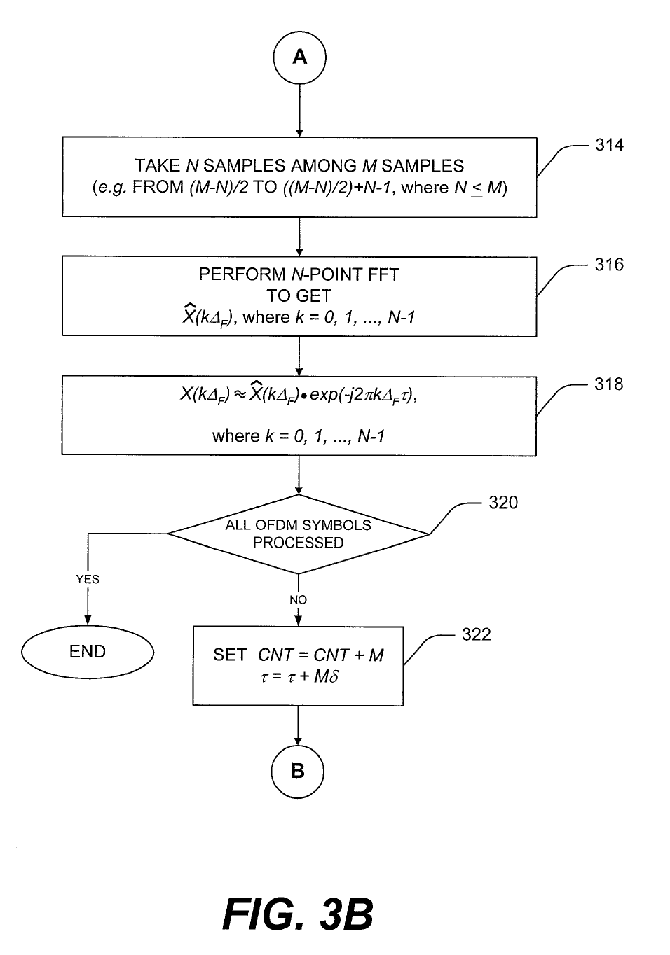

The adjustment process is described by flowcharts of FIGS. 3A and 3B in accordance with an embodiment of the present invention. In the flowcharts, the variable CNVT is a pointer to the sampling time index of samples in a sample buffer. The variable indicates a starting index of H samples to be processed as an OFDM symbol. N samples starting at some fixed offset relative to the M samples (e.g., those N samples from the ((M−N)/2)^{th} sample to the [((M−N)/2)+N−1]^{th} may be used for the FFT operation. Note that N≦M.

The timing offset adjustment process includes initializing the timing error over one sampling duration (δ), and setting variables τ (accumulated timing error) and CNT to zero, at 300. If the timing error δ is greater than zero (at 302), the accumulated error τ is compared to T_{S}+δ, at 304. T_{S} represents the sampling duration of the source. If the accumulated error τ is greater than T_{S}+δ, then τ is set to previous value of τ minus T_{S}+δ, at 306. Further, the variable CNT is decremented by one. Otherwise, if the timing error δ is less than or equal to zero (at 302), the accumulated timing error δ is compared to −(T_{S}+δ), at 308. If τ is less than −(T_{S}+δ), then τ is set to previous value of τ plus T_{S}+δ, at 310. Further, the variable CNT is incremented by one.

M samples of indices from sample buffer are taken, at 312. For example, samples CNT to CNT+M−1 may be taken. At 314, N samples among the M samples are taken, where N is less than or equal to M. For example, samples (M−N)/2 to ((M−N)/2)+N−1 may be taken.

N-point FFT is performed, at 316, to get the estimated modulating symbol for the k-th sub-carrier, \hat{X}(kΔ_{F}). Then, at 318, the actual modulating symbol, X(kΔ_{F}), is computed as X(kΔ_{F})≈\hat{X}(kΔ_{F})·exp(−j2πkΔ_{F}τ), where k=0, 1, . . . , N−1. Thus, if there are more OFDM symbols to be processed (at 320), The variables CNT and τ are incremented (at 322) by M and Mδ, respectively, and the method loops back to the top (at 302) to process the next OFDM symbol.

At the receiver, the middle N samples of M samples typically used for demodulation (i.e., sample number (M−N)/2 to sample number (N−1)+((M−N)/2)). If LMδ/(T_{S}+δ) is outside the range of ±1, then skipping forward or backward several samples may be considered to maintain the N samples within the same OFDM symbol as shown in the equations (12) and (15).

In an alternative embodiment, to obtain more exact results without approximation (especially when |δ| is large relative to the source sampling duration, T_{S}), the multiplier of the fast Fourier transform (FFT) in equation (12), exp(j2πkn/N), may be modified using the butterfly structure. By rewriting equation (12),

$$\begin{matrix}X ( {kΔ}_{F} ) = \frac{1}{N} {\sum }_{n = 0}^{N - 1} x ( n ( {T}_{s} + δ ) + τ ) \cdot exp ( - j2πkn / N ) \cdot exp ( - {j2πkΔ}_{F} ( nδ + τ ) ) \\ = \{ \frac{1}{N} {\sum }_{n = 0}^{N - 1} x ( n ( {T}_{s} + δ ) + τ ) \cdot {\tilde{W}}_{N}^{nk} \} \cdot exp ( - {j2πkΔ}_{F} τ )\end{matrix} \qquad ( 17 )$$

where \tilde{W}_{N}^{nk}=(exp(−j2π(1+δ/T_{S})/N))^{nk} and Δ_{F}T_{S}=1/N. Therefore, the multiplier \tilde{W}_{N}^{nk}=(exp(−j2π(1+δ/T_{S})/N))^{nk} may be used in place of the multiplier W_{N}^{nk}=exp(−j2πkn/N) in FET butterfly operation. The resulting N FFT outputs may be rotated appropriately by multiplying exp (−j2πkΔ_{F}τ) for each k. The same technique may be used to select which N samples are used for FFT operation. The selection may be based on the total accumulated delay or accumulated timing error τ.

For OFDM systems, preamble (which has known signal format to the destination node and precedes any data sequence unknown to the destination node) is usually used for channel estimation since any transmission media may cause attenuation (scale) and phase rotation. The preamble may also be used for timing synchronization. Once the scale and phase rotation are estimated by demodulating the preamble and compared with the known format, the channel condition may be constant over a short period (e.g., several milliseconds). However, some corrections proportional to the accumulated timing error/offset are needed to recover X(kΔ_{F}), as mentioned above. Similar treatments may be used for modulator/transmitter using IFFT to generate OFDM signals when there is a fixed clock frequency offset between the source and the destination.

For cellular systems, base stations provide frequency/timing references while mobile stations adjust frequency/timing in order to achieve better performance. For example, in HiperLAN2 systems, Access Point/Central Controller (AP/CC) are the references while Mobile Terminal (MT) adjusts frequency/timing to achieve desired performances. In HiperLAN2, any device may acquire the control channel message when initial frequency offset is within ±20 PPM. This means that the clock frequency error is 20 PPM if the same reference oscillator is used in the devices. As a comparison, GSM requires 5 PPM for initial frequency offset.

There has been disclosed herein embodiments for improved frequency and time synchronization of the digital transmitters and receivers. In one embodiment, a frequency offset adjustment system includes a sine function look-up table interpolator that provides interpolated values of sine and cosine function samples. This enables the look-up table to be configured as small as possible. In another embodiment, removal of the effect of accumulated timing error for OFDM receivers/transmitters without adjusting the local sampling clock is enabled. Therefore, the effect of the accumulated timing error due to the fixed clock frequency offset between the source node and the destination node may be removed without adjusting the local clock frequency.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the embodiments may be practiced without some of these specific details. In other instances, well-known structures and functions were not described in elaborate detail in order to avoid obscuring the subject matter of the present invention. Accordingly, the scope and spirit of the invention should be judged in terms of the claims which follow.

What is claimed is:

1. A frequency offset adjustment system for a digital signal, comprising:
a sine function look-up table to provide sine sample values at an interval close enough to produce said sine sample values with sufficient accuracy, but far enough to enable reduction in size of the look-up table;
an interpolator to receive said sine sample values, and to produce sine and cosine sample values at a particular input phase value between said sine sample values by using numerical interpolation; and
an adjusting element configured to receive the digital signal, and to adjust frequency offset on the signal by mixing samples of the signal with said sine and cosine sample values calculated based on sample index of the signal samples and the frequency offset.

2. The system of claim 1, wherein said frequency offset adjustment system is a digital tuner.

3. The system of claim 1, wherein said adjusting element includes mixing elements and summing elements.

4. The system of claim 3, wherein said mixing elements are product elements.

5. The system of claim 1, wherein said interpolator includes means for performing interpolation to produce said sine sample value at a particular phase value as
$$sin ( 2 πΔ {fiT}_{s} ) = \frac{R - m}{R} sin\_table [ n \% S ] + \frac{m}{R} sin\_table [ ( n + 1 ) \% S ] ,$$
where Δf is the frequency offset, i is the sampling index, T_{S} is a sampling duration, R is a resolution factor, m=iK%R, K is a scaling factor, % is a modulus division operator, S is the size of the look-up table, and 0≦n<S.

6. The system of claim 1, further comprising:
a quadrature symmetry element to reduce the size of the look-up table by at least four, said quadrature symmetry element using symmetry of a sine function value about x and x, where said quadrature symmetry element include a two-bit control word used to select appropriate sign of said value.

7. The system of claim 1, wherein said interpolator includes means for performing interpolation to produce said cosine sample value at a particular phase value as
$$cos ( 2 πΔ {fiT}_{s} ) = \frac{R - m}{R} sin\_table [ ( n + \frac{S}{4} ) \% S ] + \frac{m}{R} sin\_table [ ( n + 1 + \frac{S}{4} ) \% S ] ,$$
where Δf is the frequency offset, i is the sampling index, T_{S} is a sampling duration, R is a resolution factor, m=iK%R, K is a scaling factor, % is a modulus division operator, S is the size of the look-up table, and 0≦n<S.

8. A method for adjusting frequency offset of a digital signal, comprising:
providing a sine look-up table whose sine sample values are at an interval close enough to provide said sine sample values with sufficient accuracy, but far enough to enable reduction in size of the look-up table; and
producing sine and cosine sample values at a particular input phase value between said sine sample values by using numerical interpolation.

9. The method of claim 8, wherein said producing includes determining a table index (n) to send to the look-up table.

10. The method of claim 9, where said determining includes computing
$$\frac{iK}{R} such that n < \frac{iK}{R} < n + 1 ,$$
where i is a sampling index, T_{S} is a sampling duration, R is a resolution factor, and K is a scaling factor.

11. The method of claim 8, wherein said producing includes determining a parameter (m) to perform said numerical interpolation.

12. The method of claim 11, where said determining includes computing m=iK%R, where i is a sampling index, K is a scaling factor, % is a modulus division operator, and R is a resolution factor.

13. The method of claim 8, wherein said producing includes interpolating between said sample values by computing sin (2πΔfiT_{S})=
$$\frac{R - m}{R} sin\_table [ n \% S ] + \frac{m}{R} sin\_table [ ( n + 1 ) \% S ] ,$$
where Δf is a frequency offset, i is a sampling index, T_{S} is a sampling duration, R is a resolution factor, m=iK%R, K is a scaling factor (K>0), e is a modulus division operator, S is the size of the look-up table, and 0≦n<S.

14. The method of claim 13, wherein when K is less than zero, said producing includes interpolating by computing
$$sin ( 2 πΔ {fiT}_{s} ) = \frac{R - m}{R} sin\_table [ n \% S ] + \frac{m}{R} sin\_table [ ( n + 1 ) \% S ] ,$$
where
m=−iK%R and changing a sign of a resulting sine sample value.

15. The method of claim 8, wherein said producing includes interpolating between said sample values by computing cos(2πΔfiT_{S})=
$$\frac{R - m}{R} sin\_table [ ( n + \frac{S}{4} ) \% S ] + \frac{m}{R} sin\_table [ ( n + 1 + \frac{S}{4} ) \% S ] ,$$
where Δf is a frequency offset, i is a sampling index, T_{S} is a sampling duration, R is a resolution factor, m=iK%R, K is a scaling factor (K>0), % is a modulus division operator, S is the size of the look-up table, and 0≦n<S.

16. The method of claim 15, wherein when K is less than zero, said producing includes interpolating by computing
$$cos ( 2 πΔ {fiT}_{s} ) = \frac{R - m}{R} sin\_table [ ( n + \frac{S}{4} ) \% S ] + \frac{m}{R} sin\_table [ ( n + 1 + \frac{S}{4} ) \% S ] ,$$
where m=−iK%R.

17. A method for adjusting an accumulated timing offset of a digital signal by selecting appropriate samples of the digital signal without adjusting local sampling clock frequency, comprising:
first taking M samples of sample indices from a sample buffer;
second taking N samples among M samples;
performing N-point fast Fourier transform (FFT) to determine an estimated modulating symbol for k-th sub-carrier; and
determining a modulating symbol for the k-th sub-carrier by multiplying the estimated symbol by exp(−j2πkΔ_{F}τ), where k=0, 1, . . . , N−1 and τ is the accumulating timing offset.

18. The method of claim 17, further comprising:
initializing a timing offset over one sample (δ), the accumulating timing offset (τ) to zero, and a counter (CNT) to zero.

19. The method of claim 18, further comprising:
updating the accumulated timing offset (τ) to a previous value minus a destination sampling duration (T_{sd}) when the timing offset over one sample (δ) is greater zero and the accumulated timing offset (τ) is greater than the destination sampling duration,
where the destination sampling duration (T_{sd}) is a sum of source sampling duration (T_{S}) and the timing offset over one sample (δ).

20. The method of claim 19, further comprising:
decrementing the counter (CNT) by one.

21. The method of claim 18, further comprising:
updating the accumulated timing offset (τ) to a previous value plus a destination sampling duration (T_{sd}), when the timing offset over one sample (δ) is less than or equal to zero and the accumulated timing offset (τ) is less than negative of the destination sampling duration, −T_{sd},
where the destination sampling duration is a sum of source sampling duration (T_{S}) and the timing offset over one sample (δ).

22. The method of claim 21, further comprising:
incrementing the counter (CNT) by one.

23. The method of claim 18, wherein said first taking M samples includes taking samples from CNT to CNT+M−1.

24. The method of claim 18, further comprising:
incrementing the counter (CNT) and the accumulated timing error (τ) by M and Mδ, respectively, if there are more OFDM symbols to be processed.

25. The method of claim 17, wherein said second taking N samples includes selecting any consecutive N samples among the M samples, which includes taking samples of indices from (M−N)/2 to ((M−N)/2)+N−1, where N less than or equal to M.
